(19) United States
(12) Patent Application Publication
(10) Pub. No.: US 2010/0005463 A1
(43) Pub. Date: Jan. 7, 2010

(54) METHOD, SYSTEM, AND PROGRAM FOR AUTOMATICALLY CHANGING KEYBOARD LAYOUT SETTINGS

(75) Inventors: Belinda Ying-Chieh Chang, Cary, NC (US); Shruti Gandhi, Poughkeepsie, NY (US); Angela Richards Jones, Durham, NC (US); Pamela Ann Nesbitt, Tampa, FL (US); Anne Irene Ryan, Palo Alto, CA (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: International Business Machines Corporation, Armonk, NY (US)

(21) Appl. No.: 12/167,266

(22) Filed: Jul. 3, 2008

(51) Int. Cl. G06F 9/445

(52) U.S. Cl. 717/178

(57) ABSTRACT

A user visiting a computer other than his or her customary one logs on to a website or email server where the user's personal keyboard preference profile has been stored. The personal preferences are downloaded via the browser to the computer being used, and passed to its operating system via an Applications Programming Interface where the computer can install the personal preference profile as the temporary keyboard layout profile. The original keyboard layout of that computer is retrieved from the operating system and sent to the website or email for temporary storage so that the original layout may be restored once the user is finished.

### FIELD OF THE INVENTION

This invention relates generally to computing environments where users employ keyboards for text, data, document creation and any of a host of other applications, and more specifically it relates to changing the functional keyboard layout to accommodate a specific user's personal keyboard functional equivalence so that the keys on the keyboard of, say, a computer not normally used by the user, will be automatically redefined to match the user's personal preferences and then restored to their original settings when the user is done using the keyboard.

### BACKGROUND

Computer users are familiar with the physical layouts of commonly employed keyboards such as the standard QWERTY or alternatively, the DVORAK layout of keys on the keyboard. However, it is also very common for a given user to establish a profile of personal keyboard functional equivalents for the meaning to be associated with individual keys such as function keys or keys with special shortcut functions.

Other personal preference changes to the keyboard are related to the language in which the user normally wishes to write or communicate or to specific programming statements that the user may frequently make while using the keyboard to create applications programs or other computer code.

Indeed, numerous software programs are available either free or for fee downloading that enable a user to customize their own keyboard preferences as evidenced by the many offerings of such software on http://www.bluechillies.com/ specifically created to allow the user to customize their keyboard functional layout. However, if the user is not using his or her own customized keyboard but is using another computer and keyboard say in another office or at another user's station, customizing that other user's keyboard might not be received with pleasure.

There are several possible solutions to this problem such as manually changing the keyboard functional layout, preferred language or shortcuts that are available to user's running Linux or Windows operating systems, but these require time and effort on the part of the user. Alternatively, the user's own keyboard functional layout preferences could be recorded on a portable data memory medium such as a flashcard or smart card or memory stick to load the user's personal preferences into the computer. Use of a smartcard for such a purpose is shown in U.S. Pat. No. 7,177,915. But this type of solution requires the special smart card or other portable device to be carried about and employed by the user whenever he or she wishes to use some computer other that the one he or she customarily uses and it requires special hardware and software at the other computer to detect and read the smartcard.

### SUMMARY

The present invention solves these problems by providing a method and system that enable a user to store his or her personal keyboard layout preferences and shortcuts in a file in a web account such as email, Google or Yahoo or any web site or service that enables a user to store securely his or her private information for access only when such user logs onto the web site. When the user visits or uses a computer other than the one he or she customarily uses and has already customized with their personal keyboard layout functional preferences, it is an easy thing to simply log on to the website or email server where the user's personal keyboard preference profile has been stored, download it via the browser to the computer being used, and pass it to the operating system of the computer via an Applications Programming Interface (API). The currently-existing keyboard functional layout of that computer can be retrieved from the operating system and sent to the website or email for temporary storage so that the original keyboard layout functions may be restored again once the user is finished using the alternate computer.

The present invention provides a method, system and program for providing a user of a computer system an easy way to automatically configure the keyboard functional layout of such computer to his or her previously established tastes in choice of keyboard layout, shortcuts, language or any other user-choice variable that may be selected for defining the functions of the keys on a typical computer keyboard. The user first establishes an on-line account such as email or other server access where the user can securely store his or her preferred keyboard functional key assignments. Then, when using a computer not already configured with the user's preferred key assignments, the user can simply log on to the email or other secure web account where his or her personal key assignment functional profile is stored, download it by using the browser in the computer, and pass the new key assignment parameters via an API to the operating system of the computer to configure the keyboard key functional assignments in accordance with his or her profile. The existing keyboard key assignment table is retrieved from the computer and sent to the on line account of the user for safekeeping while the user employs the computer for any tasks he or she desires to accomplish. The system and method of the invention then restores the originally-existing key assignments to the computer when the user logs off the computer.

### BRIEF DESCRIPTION OF THE DRAWINGS

The foregoing and other objects and advantages of the invention will be appreciated more fully from the following further description thereof with reference to the accompanying drawings, wherein:

FIG. 1 illustrates schematically the block diagram of the elements of a computer system having internet access and shows the general flow of data that allows retrieval of the user's keyboard layout preference profile from an on-line account, passing it to the computer system's operating system (OS), storing the computer's originally-existing keyboard layout preference table in the on line account for safekeeping and restoring this table back to the OS when the user logs off the computer or signs out from the email or other on-line account where the preference profiles are kept; and

FIG. 2 illustrates the preferred method, process and program of an embodiment of the invention which performs the various tasks schematically depicted in FIG. 1.

### DETAILED DESCRIPTION

The invention will now be described in detail with reference to a preferred embodiment thereof as illustrated in the Drawings mentioned above.

The invention provides a simple way for the user of a computer that has not been configured with the user's preferred keyboard functional layout to invoke an automatic process that will save the currently-existing keyboard functional layout or key function assignment table from the computer, retrieve the user's preferred key function assignments that comprise the user's preferred keyboard layout from safe storage, conveniently located in any on-line account where data may be securely stored, and install that preferred key assignment functional table to the computer's OS for use while the user employs the computer. Then, upon the user's logging off the on-line account or ending use of the computer, the originally programmed preferences from the computer are retrieved from on-line storage and restored in the computer, thus returning it to the original state in which the user found it.

As is well known, the layout of a computer or other keyboard has mechanical, visual and functional or logical aspects. The mechanical aspects relate to the placement and shapes of the various keys of the keyboard. The visual aspects relate to the arrangement of the legends or markings that appear on the keys, and the functional or logical aspects of the keyboard layout relate to the meanings to be associated with activation of the keys, the latter aspect being controlled by software in the OS of the computer.

Typically, when a keyboard key is activated, the keyboard sends signals to the computer identifying which key has been activated, such as “left-most key of home row”. The meaning to be associated with the activation of such a key is the function of a programmed key assignment table stored in the computer's OS. The table may define that such a key is the letter “a”, or that some entirely different result such as a numeral, an assigned function, or a programming shortcut is to be indicated to the computer system.

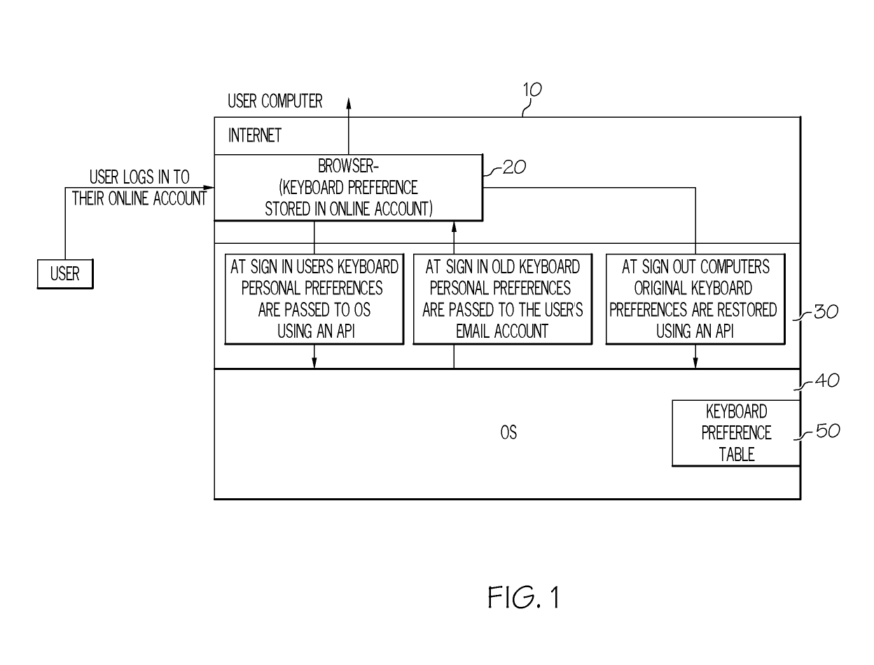

Turning to FIG. 1, the user is assumed to be at a computer system, 10, that is not the system normally used or previously configured with keyboard layout preferences by the user. The user logs on to any convenient on-line server or account he or she may have access to by use of the browser 20 in the computer system 10. When the user signs in to their on line account, the user's personal keyboard preference table of key assignments is retrieved from storage at the server and delivered by the browser 20 to the computer's operating system 40 via an API 30. The computer's currently existing keyboard layout or preference assignment table 50 is first retrieved by the API and passed to the browser 20 which stores the existing user-preference or key assignment table in the on-line account storage. The system then loads the OS with the user's own preferred keyboard layout profile or key assignment table as retrieved from the on-line account storage, and configures the computer system with the desired keyboard layout for the user.

Keyboard layout preferences may include choice of language, which itself requires numerous keys to be re-assigned to mean new characters or numbers or punctuation or emphasis characters, may include total re-location of the existing key assignments such as from QWERTY to Dvorak, and/or may include re-assignment of keys normally used for functions such as textual or programming functions, all of which may suit the personal desires of the user more effectively than the existing keyboard layout when the user first begins use of the computer system.

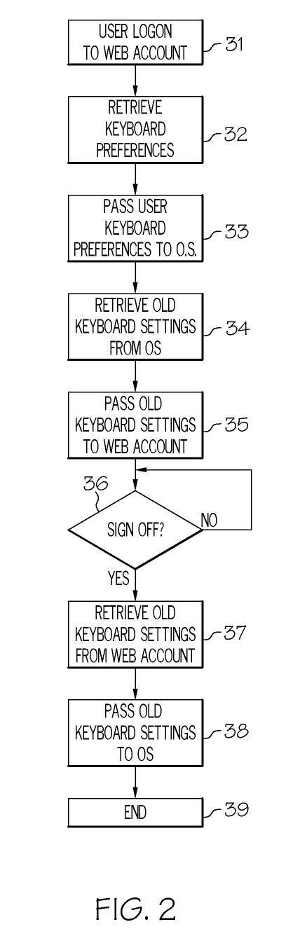

The process generally described above with reference to FIG. 1 is shown in greater detail in FIG. 2 where a preferred embodiment of the method, process or program of the invention is illustrated in more detail.

Turning to FIG. 2, the process begins in box 31 with the user logging on to their on line account at a server or other system where the user has previously securely stored his or her keyboard layout or key assignment preference table. The user retrieves such layout information and the necessary computer programming of the process of the invention by logging on to his or her account as shown by box 32 and, when properly identified, as is customary, the account automatically passes the keyboard layout data and process programming to the browser which in turn passes it as shown in box 33 via the API to the OS of the computer where it may be installed as the new keyboard layout preference table and the computer process of the invention is installed for execution in the OS. However, the process must first preserve the existing keyboard layout or key assignment table, so the process retrieves the existing or “old” keyboard layout table from the OS as shown by box 34 in FIG. 2. The process then passes the old keyboard layout table to the on-line account via the browser, and the existing keyboard layout data is stored there for later use in restoring the original keyboard layout when the user is finished using the computer system.

The process continues after establishing the new keyboard layout table in the OS by monitoring in box 36 for the user to sign off of the on-line account, signifying that he or she is finished using the computer system, or, in the alternative, monitors for logoff from the computer system by the user, signifying he or she is finished. When such an event is found, the process first retrieves the old keyboard layout table from the on-line account as shown by box 37 of FIG. 2.

Then the process passes the old, or originally-present, keyboard layout table back to the OS as shown in box 38 and, when this is complete, the process ends at box 39.

While the process of the preferred embodiment is shown in FIG. 2 as a general flow schematic, it will be easily appreciated that it can be embodied as a computer program using any of a variety of programming languages. It will be appreciated that the keyboard layout table of the user's preferred layout is retrieved from the on line account together with the necessary process code to carry out the method of the invention and installed in the OS of the computer system for execution.

It is somewhat arbitrary as to whether the computer process first retrieves the old keyboard layout from the OS or loads the new keyboard layout table first, so long as the old or pre-existing keyboard layout table is preserved and passed to the browser and then on to the on line account for secure storage as described. The specific order of these steps may be changed, so long as the principle of preserving the existing functional keyboard layout or table is maintained. The preferred embodiment is written so that the OS receives the new, user-preferred keyboard layout table, retrieves and passes the old keyboard layout table to the browser and then installs the new keyboard layout for use.

Having thus described the invention with reference to a preferred embodiment thereof, it will be apparent to those of skill in this art that the invention would be implemented in any particular computer system with ease, wherefore the invention as described in the following claims is not limited to any particular computer system or to any particular programming language or technique.

What is claimed is:

1. An enhanced system for establishing a user's preferred keyboard functional profile as the operational keyboard layout in a computer system having an operating system and on-line internet access facilities, comprising:
means for accessing an on-line account of a user; means for retrieving from said on-line account, the user's preferred keyboard functional profile data and installation code;
means for passing said functional profile data and installation code to the system's operating system for execution;
means in said installation code for preserving the existing system's keyboard functional profile;
means in said installation code for installing said user's preferred keyboard function profile as the operational keyboard functional profile in said operating system;
means in said installation code for detecting that the user has finished using the computer system; and
means in said installation code responsive to said detecting for re-establishing said existing system's keyboard functional profile as the operational profile in said system by accessing said preserved existing system's keyboard functional profile and installing said profile in said operating system.

2. The enhanced system of claim 1, further comprising:
means in said installation code for detecting that the user has finished using the computer system; and
means in said installation code responsive to said detecting for re-establishing said existing system's keyboard functional profile as the operational profile in said system by accessing said preserved existing system's keyboard functional profile and installing said profile in said operating system.

3. The enhanced system of claim 1, wherein:
said means in said installation code for preserving the existing system's keyboard functional profile comprises means for retrieving said existing system's keyboard functional profile from said operating system; and
means for passing said retrieved existing system's keyboard functional profile to said means for accessing said on line account of said user.

4. The enhanced system of claim 1, wherein:
said means in said installation code for detecting that the user has finished using the computer system comprises code for monitoring the user's logon status to said on-line user account and, responsive to a logoff from said account by said user for initiating said re-establishment of said preserved keyboard layout profile in said operating system of said system.

5. A method for establishing a user's preferred keyboard functional profile as the operational keyboard layout in a computer system having an operating system and on-line internet access facilities, comprising computer executable steps of:
accessing an on-line account of said user;
retrieving from said on-line account, the user's preferred keyboard functional profile data and installation code;
passing said functional profile data and installation code to the system's operating system for execution;
preserving the existing system's keyboard functional profile; and
installing said user's preferred keyboard function profile as the operational keyboard functional profile in said operating system.

6. The method of claim 5, further comprising computer executable steps for:
detecting that the user has finished using the computer system; and
re-establishing said existing system's keyboard functional profile as the operational profile in said system by accessing said preserved existing system's keyboard functional profile and installing said profile in said operating system.

7. The method of claim 5, further comprising computer executable steps for:
preserving the existing system's keyboard functional profile comprises computer executable steps for retrieving said existing system's keyboard functional profile from said operating system; and
passing said retrieved existing system's keyboard functional profile to said on line account of said user.

8. The method of claim 5, further comprising computer executable steps for:
detecting that the user has finished using the computer system by monitoring the user's logon status to said on-line user account and, responsive to a logoff from said account by said user, initiating said re-establishment of said preserved keyboard layout profile in said operating system of said system.

9. A program product for establishing a user's preferred keyboard functional profile as the operational keyboard layout in a computer system having an operating system and on-line internet access facilities comprising machine executable instructions for:
accessing an on-line account of a user;
retrieving from said on-line account, the user's preferred keyboard functional profile data and installation code;
passing said functional profile data and installation code to the system's operating system for execution;
preserving the existing system's keyboard functional profile; and
installing said user's preferred keyboard function profile as the operational keyboard functional profile in said operating system.

10. A program product as described in claim 9, further comprising machine executable instructions for:
detecting that the user has finished using the computer system; and
re-establishing said existing system's keyboard functional profile as the operational profile in said system by accessing said preserved existing system's keyboard functional profile and installing said profile in said operating system.

11. A program product as described in claim 9, further comprising machine executable instructions for:
preserving the existing system's keyboard functional profile by retrieving said existing system's keyboard functional profile from said operating system; and
passing said retrieved existing system's keyboard functional profile to said on line account of said user.

12. A computer program product as described in claim 9, further comprising machine executable steps for:
monitoring the user's logon status to said on-line user account and, responsive to a logoff from said account by said user for initiating said re-establishment of said preserved keyboard layout profile in said operating system of said system.
